(19) United States
(12) Patent Application Publication
(10) Pub. No.: US 2026/0326183 A1
(43) Pub. Date: Oct. 22, 2026

(54) DEVICE FOR SHEARING MOULDS FOR SHEETS FOR ELECTRICAL USE

(71) Applicant: CORRADA S.P.A., Lainate (IT)

(72) Inventors: Mario CHECCHIN, Tradate (IT); Hamed KHAJEHMIRZA, Rho (IT)

(21) Appl. No.: 19/104,786

(22) PCT Filed: Aug. 2, 2023
(86) PCT No.: PCT/IB2023/057832

§ 371 Date: Feb. 19, 2025

(30) Foreign Application Priority Data
Aug. 24, 2022 (IT) 102022000017547

(51) Int. Cl. B21D 28/22; B21D 28/24; B21D 37/04

(52) U.S. Cl. CPC B21D 28/22; B21D 28/246; B21D 37/04

(57) ABSTRACT

A device for shearing molds for sheets for electrical use for forming lamellar packs for electrical use in electrical machines such as motors, generators, transformers, counters, ignition coils and similar electrical equipment. The device includes a box-like body housed inside a plate of a shearing mold. The device includes means for a simultaneous or selective activation/deactivation of shearing punches of the shearing mold in a shearing step. The activation/deactivation means corresponds in number to the number and position of the shearing punches.

The present invention relates to a device for shearing moulds for sheets for electrical use.

More in particular, the present invention relates to a device applied in shearing moulds for making metal sheets functional for forming lamellar packs for electrical use in electrical machines such as motors, generators, transformers, counters, ignition coils and similar electrical equipment.

As is known, the magnetic sheets necessary for forming lamellar packs are obtained starting from a metal sheet subjected to shearing operations by means of dedicated moulds which, for the purpose, comprise elements which in jargon are defined “special functions”, i.e., mechanical elements of a mould activated manually or by a pneumatic or hydraulic piston which enable/disable one or more shearing elements of a mould.

An example of a “special function” is a type of sheet packaging made in progressive moulds in which the sheets which are superimposed are each provided with protruding braces which go to define a cavity at the opposite surface (with respect to that of the brace) and with the brace of a sheet which is constrained in the cavity of the adjacent sheet and with a further sheet which is interposed between two adjacent sheets constrained together and which is provided with a through opening adapted to be crossed by the brace of a sheet which couples with the cavity of the adjacent sheet; in this case the special function is activated and deactivated at each press stroke.

In a progressive type mould such as the one described above for the specific packaging solution, there may be a plurality of “special functions” and by means of activating/deactivating such functions it is possible to activate or deactivate the shearing punches and thereby obtain sheared products (e.g., sheets) with multiple geometries or shapes.

Typically, the activation/deactivation of the above functions occurs by means of dedicated apparatuses placed within the mechanical structures of the shearing moulds and comprising movement bars, sliders and containment plates thereof which require considerable spaces and which are driven by an external control and command unit by means of pneumatic or hydraulic pulses.

Therefore, the traditional apparatuses have a significant drawback represented by the considerable dimensions and weight of said apparatuses.

Known solutions of this type are described in U.S. Pat. Nos. 4,623,089 or 5,144,872 or 8,770,077, which describe shearing moulds, characterized by complex mechanical structures with considerable dimensions and weights.

A further drawback of the traditional apparatuses is that they are capable of activating the shearing punches only simultaneously in each shearing step.

A further drawback of the traditional type of apparatus is represented by mechanical problems defined by breakage and jamming of the mechanisms for activating/transmitting the movements to the shearing punches.

Known solutions having these types of drawbacks are described in EP0963802 or DE202005010990 or EP3789133 or DE4135787 or U.S. Pat. Nos. 5,771,565, which refer to shearing devices comprising a plurality of punches whose movement is activated/deactivated as a function of shearing needs with mechanical means of the piston or lever type.

A further drawback, and consequence of the above drawback is represented by the costs of maintenance, replacement, repair of the broken or jammed mechanisms, which affect production costs.

The object of the present invention is to overcome the drawbacks described above.

More in particular, the object of the present invention is to provide a device for shearing moulds for electrical use with limited dimensions and such that it can be easily installed within a shearing mould.

A further object of the present invention is to provide a device which reduces, if not considerably cutting down, the chances of witnessing any breakage and/or jamming of the mechanisms for transmitting the motion to the shearing punches. A further object of the present invention is to provide a device for shearing moulds which allows the shearing punches to be activated simultaneously or selectively/individually within the same shearing step.

A further object of the present invention is to provide a device for shearing moulds which is simple to manage with reference to maintenance or repair or replacement interventions, with a containment of the related costs.

A further object of the present invention is to provide users with a device for shearing moulds for electrical use adapted to ensure high reliability and resistance over time and such as to be easily and economically made.

These and other objects are achieved by the invention having the features according to claim 1.

According to the invention, a device is provided for shearing moulds for sheets for electrical use functional for forming lamellar packs for electrical use in electrical machines such as motors, generators, transformers, counters, ignition coils and similar electrical equipment, comprising a box-like body housed inside a plate of a shearing mould and comprising means for a simultaneous or selective activation/deactivation of shearing punches of said shearing mould in a shearing step, said activation/deactivation means being in corresponding number to the number and position of said punches.

Advantageous embodiments of the invention appear from the dependent claims. The constructive and functional features of the device for shearing moulds for sheets for electrical use of the present invention can be better understood from the following detailed description, in which reference is made to the attached drawings which illustrate an embodiment provided solely by way as a non-limiting example, in which:

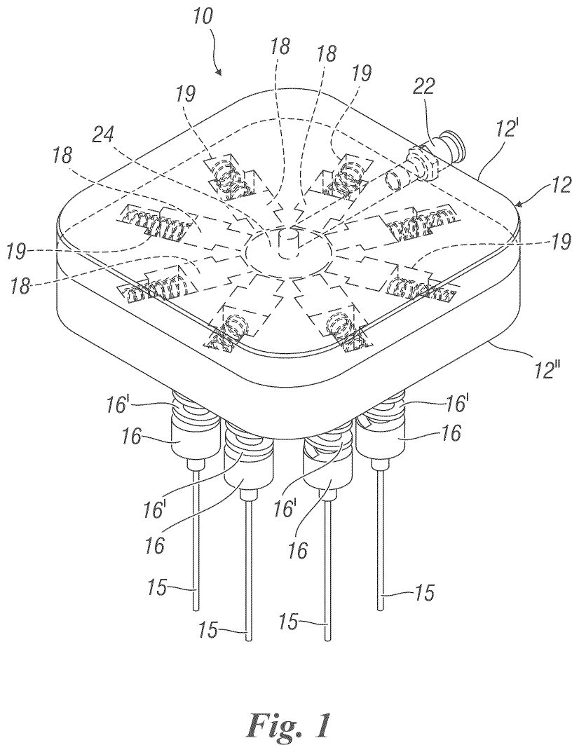

FIG. 1 schematically illustrates an axonometric view of the device for shearing moulds for sheets for electrical use of the present invention;

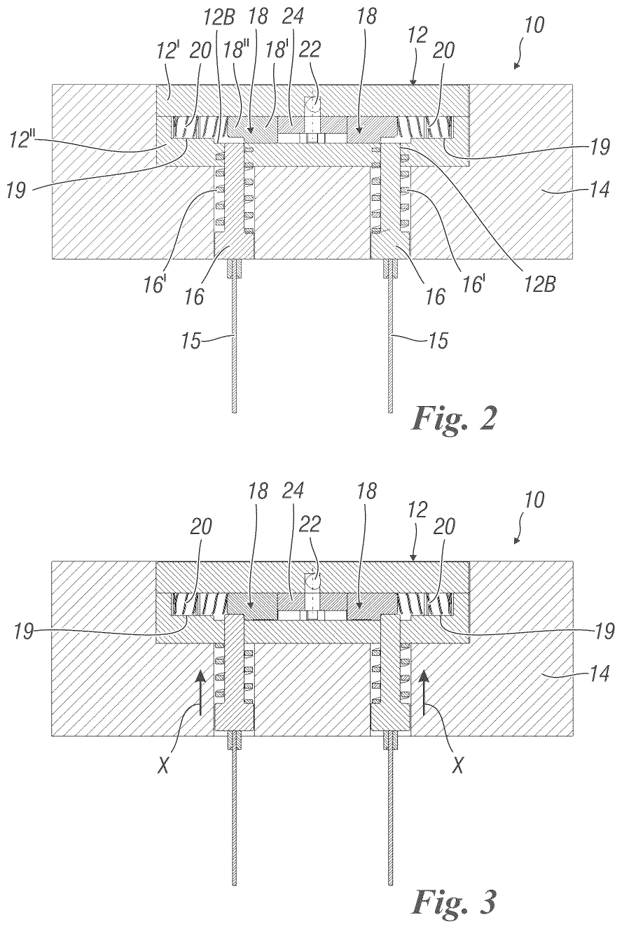

FIG. 2 schematically illustrates a view of the device of the invention in cross-section according to a vertical plane;

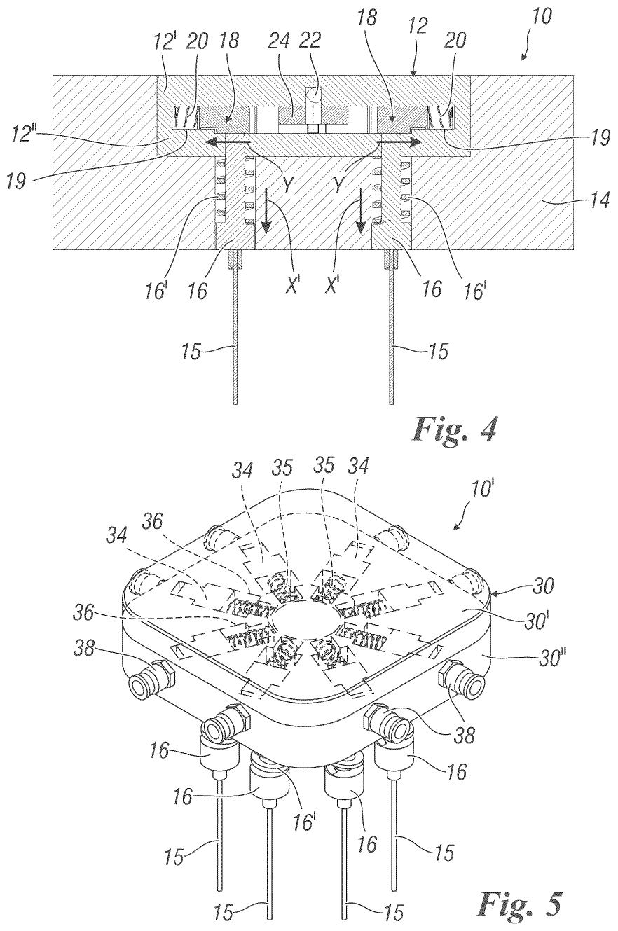

FIGS. 3 and 4 schematically illustrate a cross-sectional view of the device of the invention according to a vertical plane, with each figure illustrating the movement sequence of the device of the invention;

FIG. 5 schematically illustrates an axonometric view of the device of the invention according to an embodiment alternative to the embodiment referred to in FIGS. 1 to 4;

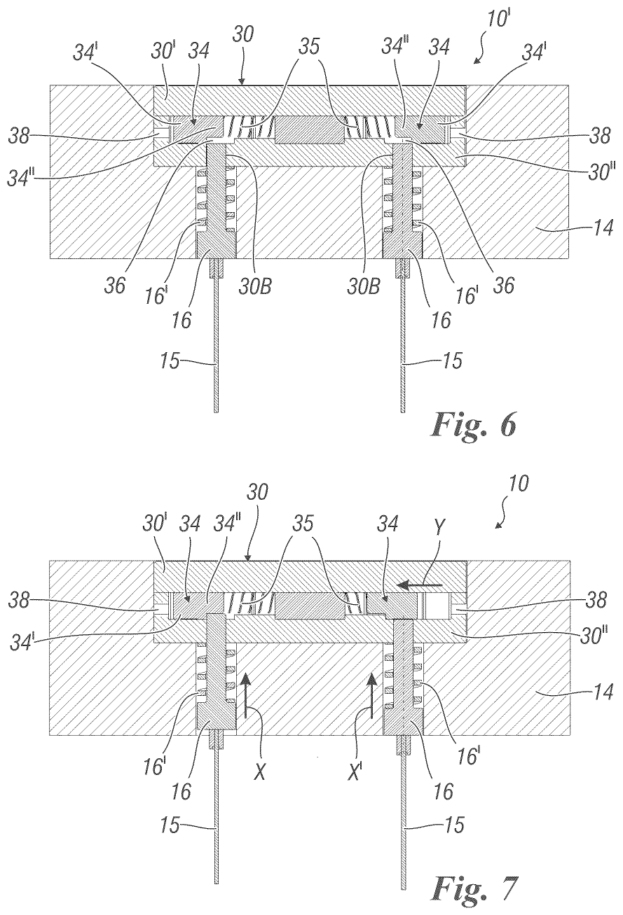

FIGS. 6 and 7 schematically illustrate a view of the device of FIG. 5 in cross-section according to a vertical plane, with each figure illustrating the movement sequence of the device of the invention.

With reference to the aforementioned figures, the device for shearing moulds for sheets for electrical use of the present invention, indicated overall with 10 in FIG. 1 and in FIGS. 2 to 4, comprises a box-like body 12 adapted to be housed inside a plate 14 of a shearing mould (FIG. 2) comprising shearing punches 15 and abutting spacer means 16 for said shearing punches functional for a movement according to an advancement/retraction direction of said shearing punches according to the modes better described below for the purpose of activating/deactivating specific shearing functions (known as “special functions”). The spacer means 16 comprise elastic elements 16′ cooperating with said spacer means for an elastic return of the shearing punches 15 activated/deactivated as described below.

The spacer means 16 and therefore the shearing punches 15 are activated/deactivated in their movement by means of operating elements arranged within the box-like body 12.

The box-like body 12 comprises an upper block 12′ and a lower block 12″ hermetically and rigidly constrained to each other with retaining means of known type such as screws and the like.

The lower block 12″ has through holes or openings 12B formed in the thickness of its base and functional for accommodating a portion of the spacer means 16 to which the shearing punches 15 are connected; the number and arrangement of said through holes or openings 12B corresponds to the number and position of the shearing punches 15.

The means for activating/deactivating the shearing punches 15 are arranged within the lower block 12″, which comprise sliders 18 movable in translation within dedicated seats 19 formed in said lower block 12″, with said sliders 18 cooperating with elastic elements 20 likewise housed in said seats 19 and preferably defined by compression springs.

The sliders 18, in the preferred embodiment referred to in the figures, comprise a head portion 18′ and a tail portion 18″ (oriented in the direction of the elastic elements 20) with different dimensions in height and, in particular, with the height of the tail portion 18″ lower with respect to that of the head portion 18′.

The number of sliders 18 and, therefore, of the elastic elements 20 and of the relative housing seats 19 corresponds to the number of shearing punches 15 which must be activated/deactivated in the desired shearing step.

In the preferred embodiment referred to in the figures, the sliders 18 are arranged according to a radial direction with a forward/backward sliding movement with respect to the centre of the lower block 12″.

In accordance with alternative embodiments to that described above, the sliders 18 can be arranged in accordance with different geometries with respect to the radial one and this as a function of the specific production requirements.

The sliding movement of the sliders 18 within the seats 19 occurs by means of a flow of compressed air fed through a fitting 22 fixed to the box-like body 12 and distributed in the aforementioned seats 19 by means of a distributor assembly 24 also arranged inside the box-like body 12 at the centre thereof.

The operation of the device for shearing moulds for electrical sheets of the present invention, described above in detail with reference to its constructive features, is explained below with reference to the embodiment referred to in FIGS. 1 to 4.

With reference to FIGS. 2 and 3, the condition is illustrated in which, in a shearing stroke, the shearing punches 15 are deactivated and are not shearing.

In such a condition, the sliders 18 are in a resting end-stroke position in the respective seats 19 at the centre of the lower block 12″ of the box-like body 12 and are maintained in such a position by the action of the elastic elements 20 with the spacer means 16 and, therefore, with the shearing punches 15 which, due to the shearing force of the mould, rise (as indicated by the arrow “X” in FIG. 3) in the thickness of the mould plate 14 and in the lower block 12″ of the box-like body 12, abutting the tail portion 18″ of the slider 18 and resulting in a non-shearing action of the sheet (in particular, the spacer means 16 engage with the tail portion 18″ of the slider 18).

With reference to FIG. 4, the condition is illustrated in which, in a shearing stroke, the shearing punches 15 are activated and are shearing.

For the activation of the shearing punches 15, compressed air is fed to the box-like body 12 through the fitting 22 and distributed to the individual sliders 18 through the distributor assembly 24 and, as a result of the action of the air, the sliders 18 slide radially away from the centre of the lower block 12″, compressing the elastic means 20 (as indicated by the arrows “Y” in FIG. 4); with this sliding movement the sliders 18 go to close the through holes or openings 12B of the lower block 12″ in which portions of the spacer means 16 slide (the spacer means come into contact with the head portion 18′ of the slider 18) and the shearing punches 15 enter the die of the shearing mould and shear the large sheet to make the sheets.

Then when the shearing punches 15 must not shear during the subsequent shearing strokes, the supply of compressed air to the box-like body is disabled and the individual sliders 18 are returned to the resting position at the centre of the lower block 12″ due to the action of the elastic means 20 and the device is returned to the condition referred to in FIG. 2 or 3.

With reference to the embodiment of FIGS. 1 to 4, when compressed air is fed to the box-like body 12, the sliders 18 are slidably driven simultaneously by simultaneously activating the shearing punches 15.

With reference to FIGS. 5 to 7, an alternative embodiment of the device of the invention is illustrated, indicated overall with 10′, in accordance with which the shearing punches can be selectively activated/deactivated.

In the description of the alternative embodiment, the same reference numerals of the embodiment referred to in FIGS. 1 to 4 will be maintained to indicate the analogous components.

The device 10′ comprises a box-like body 30 comprising an upper block 30′ and a lower block 30″ hermetically and rigidly constrained to each other with retaining means of known type such as screws and the like.

The lower block 30″ has through holes or openings 30B formed in the thickness of its base and functional for accommodating a portion of the spacer means 16 to which the shearing punches 15 are connected; the number and arrangement of said through holes or openings 30B corresponds to the number and position of the shearing punches 15.

The means for activating/deactivating the shearing punches 15 are arranged within the lower block 30″, which comprise sliders 34 movable in translation within dedicated seats 36 formed in said lower block 30″, with said sliders 34 cooperating with elastic elements 35 likewise housed in said seats 36 and preferably defined by compression springs.

The sliders 34, in the embodiment referred to in the figures, comprise a head portion 34′ and a tail portion 34″ (oriented in the direction of the elastic elements 35 and of the centre of the lower block 30″ of the box-like body 30) with different dimensions in height and, in particular, with the height of the tail portion 34″ lower with respect to that of the leading portion 34′.

The number of sliders 34 and, therefore, of the elastic elements 35 and of the relative housing seats 36 corresponds to the number of shearing punches 15 which must be activated/deactivated in the desired shearing step.

In the embodiment referred to in the figures, the sliders 34 are arranged according to a radial direction with a forward/backward sliding movement with respect to the centre of the lower block 30″.

According to alternative embodiments to that described, the sliders 34 may have a different geometric arrangement as a function of the specific production requirements (as a function of the configuration of the shearing punches to be activated/deactivated).

The sliding movement of the sliders 34 within the seats 36 occurs by means of a flow of compressed air fed through fittings 38 fixed to the box-like body 30 at each slider 34 and distributed in the seats 36 of each slider 34.

The operation of the device for shearing moulds for electrical sheets of the present invention, described above in detail with reference to its constructive features, is explained below with reference to the embodiment referred to in FIGS. 5 to 7.

With reference to FIG. 6, the condition is illustrated in which, in a shearing stroke, the shearing punches 15 are deactivated and are not shearing.

With reference to FIG. 7, the condition is illustrated in which, in a single shearing stroke of the mould, not all of them are activated simultaneously, but selectively by feeding compressed air only to the fittings 38 at the shearing punches 15 to be activated and this so as to activate the sliding of only the sliders 34 corresponding to the punches 15 to be activated.

By feeding compressed air into a seat 36 through a fitting 38, the corresponding slider 34 slides in the seat 36 and moving in the direction of the centre of the lower block 30″, compresses the elastic means 35 (as indicated by the arrow “Y” in FIG. 7) and closes the through hole or opening 30B of the lower block 30″ in which the portion of the corresponding spacer means 16 slides and the corresponding shearing punch 15 enters the die of the shearing mould and shears the large sheet to make the sheets (as indicated by the arrow “X” in FIG. 7), while the non-activated shearing punch 15 (for the non-activation of the compressed air flow) is in a resting position in abutment with the tail portion 34″ of the slider 34 (as indicated by the arrow “X” in FIG. 7).

As can be seen from the foregoing, the advantages achieved by the device for shearing moulds for making sheets for electrical use of the present invention are evident.

The device for shearing moulds for making sheets for electrical use of the present invention advantageously allows to limit dimensions and weights and, therefore, can be easily installed inside a shearing mould.

A further advantage of the device of the invention is that it is simplified with respect to the traditional devices and allows a drastic reduction of the breaking and/or jamming probabilities of the mechanisms for the transmission of movement to the shearing punches.

Further advantageous is the fact that the device of the invention allows a simultaneous or selective drive of the shearing punches even during a same step of the shearing mould.

A further advantage of the device of the invention is that it does not require additional plates to be able to incorporate the movement bars and the sliders to achieve the transmission of movement to the shearing punches, as otherwise occurs in the traditional type of devices.

A further advantage of the device of the invention is the ease of maintenance, repair and/or replacement operations, which, therefore, reduces times and the related costs.

Although the invention has been described above with particular reference to embodiments given only by way of non-limiting example, numerous modifications and variations will be apparent to a person skilled in the art in the light of the above description. Therefore, the present invention intends to embrace all the modifications and variations which fall within the scope of the following claims.

1-8. (canceled)

9. A device for use in a shearing mold for making sheets for electrical use for forming lamellar packs for electrical use in electrical machines, the shearing mold having shearing punches connected to spacer means having elastic elements, the device comprising: a box-like body comprising means for a simultaneous or selective activation/deactivation of actuating elements configured to interact with the shearing punches of the shearing mold during a shearing step, said activation/deactivation means being in a number and position corresponding to those of said actuating elements and comprising sliders, movable in translation within dedicated seats formed in a lower block of the box-like body, the sliders cooperating with elastic elements housed in said seats and each comprising a head portion and a tail portion oriented in the direction of a corresponding one of the elastic elements and with different dimensions with respect to the head portion, the head portion and the tail portion configured, respectively, to close through holes or openings of the lower block and to define an abutment for the spacer means to control the activation/deactivation of the shearing punches.

10. The device according to claim 9, wherein the box-like body comprises an upper block hermetically and rigidly constrained to the lower block, the lower block having through-holes or openings formed in a thickness of its base to accommodate a portion of the spacer means which are configured to be connected to the shearing punches.

11. The device according to claim 9, wherein the elastic elements comprise compression springs.

12. The device according to claim 9, wherein the sliders are arranged according to a radial direction with a forward/backward sliding movement with respect to the center of the lower block.

13. The device according to claim 9, wherein the sliders are arranged in accordance with the arrangement configuration of the shearing punches.

14. The device according to claim 9, comprising a distributor assembly for distributing compressed air fed through a fitting in all the seats of the sliders for a sliding movement thereof and a simultaneous activation/deactivation of the shearing punches.

15. The device according to claim 9, comprising a fitting fixed to the box-like body at each slider for a selective sliding movement of said individual sliders in their respective seats for a selective activation/deactivation of the shearing punches.

16. An assembly, comprising:
a shearing mold for shearing a sheet, the shearing mold comprising: a plate having passages formed therein, spacers partially disposed in the passages, respectively, and shearing punches extending from the spacers, respectively, and wherein the shearing mold is operable to perform a shearing stroke to engage the sheet;
a device configured to activate and deactivate each of the shearing punches such that when one of the shearing punches is deactivated, the shearing punch will not shear the sheet during the shearing stroke of the shearing mold and when one of the shearing punches is activated, the shearing punch will shear the sheet during a shearing stroke of the shearing mold;
wherein the device is mounted to the plate of the shearing mold and comprises: a body having a base with openings extending into seats inside the body, respectively, sliders disposed inside the seats such that each of the sliders is movable between a blocking position, wherein the slider blocks the opening in the seat, and an unblocking position, wherein the slider does not block the opening in the seat, and elastic elements disposed in the seats to bias the sliders toward the unblocking positions, respectively;
wherein the seats with the sliders are disposed around a central portion of the body of the housing and extend radially outward therefrom;
wherein the openings of the device are aligned with the passages of the shearing mold, respectively, and wherein portions of the spacers are disposed in the openings of the device, respectively, whereby each of the shearing punches is associated with one of the sliders and one of the seats;
wherein when the device deactivates one of the shearing punches, the slider associated with the shearing punch moves into the unblocking position, which allows the spacer associated with the shearing punch to move into the seat associated with the shearing punch when a force is applied to the shearing punch during a shearing stroke, thereby causing the shearing punch to not shear the sheet; and
wherein when the device activates one of the shearing punches, the slider associated with the shearing punch moves into the blocking position, which prevents the spacer associated with the shearing punch to move into the seat associated with the shearing punch when a force is applied to the shearing punch during a shearing stroke, thereby causing the shearing punch to shear the sheet.

17. The assembly of claim 16, wherein each of the sliders has a head portion and an oppositely-directed tail portion disposed toward a corresponding one of the elastic elements, the tail portions having shorter heights than the head portions to thereby form notches in the sliders, respectively; and
wherein when the slider in one of the seats is in the blocking position, the head portion of the slider blocks the opening in the seat; and
wherein when the slider in one of the seats is in the unblocking position, the tail portion of the slider is disposed over the opening in the seat, thereby allowing a corresponding one of the spacers to move into the notch of the slider and, thus, into the seat when a force is applied to a corresponding one of the shearing punches during a shearing stroke, thereby causing the shearing punch to not shear the sheet.

18. The assembly of claim 16, wherein the device is configured to simultaneously activate all of the sheering punches and to simultaneously deactivate all of the sheering punches.

19. The assembly of claim 18, wherein the device comprises a distributor assembly disposed in the central portion of the body and connected to a fitting for receiving compressed air, wherein when the distributor assembly is supplied with compressed air through the fitting, the distributor assembly supplies the compressed air to the seats, which moves the sliders in the seats to the blocking positions, respectively, thereby activating the shearing punches, and wherein when a supply of compressed air to the distributor assembly is stopped, the sliders are moved back to the unblocking positions by the elastic elements, thereby deactivating the shearing punches.

20. The assembly of claim 19, wherein the elastic elements are disposed radially outward from the sliders, respectively.

21. The assembly of claim 16, wherein the device is configured to selectively activate the sheering punches and to selectively deactivate the sheering punches.

22. The assembly of claim 21, wherein each of the seats is connected to a fitting for receiving compressed air, wherein when one of the seats is supplied with compressed air through the fitting, the slider in the seat is moved to the blocking position, thereby activating the shearing punch associated with the slider, and wherein when a supply of compressed air to one of the seats is stopped, the slider in the seat is moved back to the unblocking position by the elastic element in the seat, thereby deactivating the shearing punch associated with the slider.

23. The assembly of claim 22, wherein the elastic elements are disposed radially inward from the sliders, respectively.

24. The assembly of claim 16, wherein the spacers comprise elastic portions for returning the shearing punches to their positions after being deactivated.
